(19) United States
(12) Patent Application Publication
(10) Pub. No.: US 2025/0001820 A1
(43) Pub. Date: Jan. 2, 2025

(54) MODULAR TRAILER TOW CONNECTOR

(71) Applicant: Stoneridge, Inc., Novi, MI (US)

(72) Inventors: Marco Antonio Avalos Ponce, Juarez (MX); Andres Julian Flores Ceja, Juarez (MX)

(21) Appl. No.: 18/745,202

(22) Filed: Jun. 17, 2024

Related U.S. Application Data
(60) Provisional application No. 63/510,483, filed on Jun. 27, 2023.

(51) Int. Cl. B60D 1/64; H01R 13/52; H01R 13/74

(52) U.S. Cl. CPC B60D 1/64; H01R 13/5213; H01R 13/741

(57) ABSTRACT

A trailer tow connector includes a plate with an aperture in a face of the plate, a cover that is pivotally supported by the plate for selectively concealing the aperture, an electrical connector that is removably received in the aperture, a locating feature that is configured to circumferentially orient the electrical connector relative to the plate, a stop that is configured to limit the electrical connector to an insertion depth relative to the face, and a retainer that is configured to secure the electrical connector to the plate at the insertion depth.

### CROSS-REFERENCE TO RELATED APPLICATION

This application claims priority to U.S. Provisional Application No. 63/510,483 filed Jun. 27, 2023.

### TECHNICAL FIELD

This disclosure relates to a trailer tow connector providing a modular design that can easily accommodate different electrical connectors based upon desired application.

### BACKGROUND

A trailer tow connection is commonly provided on trucks and some light duty vehicles to connect the electrical systems of a trailer to the tow vehicle. At least a 4-way or 7-way electrical connector is commonly provided on the vehicle's trailer tow connector with corresponding trailer connector wire terminals that provide electrical signals for the trailer's parking brake lights, turn signals, and brake lights, for example. In the case of a 7-way connector, the vehicle may also operate electric trailer brakes through the trailer tow connector and trailer connect junction. Other types of electrical connectors can also be provided on the trailer tow connector for various purposes.

Vehicle manufacturers often desire a custom trailer tow connector for its vehicle offerings and different vehicle option packages. Currently the trailer tow connector is manufactured as a unitary structure such that different trailer tow connectors require different tooling for each trailer tow connector configuration.

### SUMMARY

In one exemplary embodiment, a trailer tow connector includes a plate with an aperture in a face of the plate, a cover that is pivotally supported by the plate for selectively concealing the aperture, an electrical connector that is removably received in the aperture, a locating feature that is configured to circumferentially orient the electrical connector relative to the plate, a stop that is configured to limit the electrical connector to an insertion depth relative to the face, and a retainer that is configured to secure the electrical connector to the plate at the insertion depth.

In a further embodiment of any of the above, the plate includes two apertures that are substantially the same as one another.

In a further embodiment of any of the above, the two apertures are substantially the same in relation to at least the locating feature and the stop.

In a further embodiment of any of the above, the electrical connector is selecting from a group consisting of at least one of the following: a 7-way connector, a 4-way connector, a 12-way connector, a data connector, and an electrical outlet.

In a further embodiment of any of the above, the cover is pivotally secured to the plate at the face by a hinge, and a spring is provided at the hinge and between the plate and the cover to bias the cover to a closed position over the aperture.

In a further embodiment of any of the above, the locating feature is provided by one of a notch and a protrusion at the aperture, and by the other of the notch and the protrusion on the electrical connector. The locating feature provides a single angular orientation of the electrical connector relative to the plate.

In a further embodiment of any of the above, the stop is provided by a recessed annular ledge relative to the face and about the aperture, and by an annular lip on the electrical connector. The annular lip is seated against the annular ledge at the insertion depth.

In a further embodiment of any of the above, the retainer is provided by a gap in the annular ledge, and by a set of barbs on the electrical connector. The barbs are received in the gap and locked relative to the annular lip at the insertion depth.

In a further embodiment of any of the above, the retainer is provided by a clip that is received in a groove on the electrical connector on a side opposite the face.

In a further embodiment of any of the above, a vehicle that includes the trailer tow connector includes a component that is in communication with the electrical connector and configured to provide an electrical signal thereto.

In a further embodiment of any of the above, the component is at least one of a brake switch, a turn signal, a back-up switch, a power supply, a trailer brake controller, and a data bus.

In another exemplary embodiment, a method of assembling a modular trailer tow connector includes choosing an electrical connector, circumferentially aligning the electrical connector relative to an aperture in a plate, inserting the electrical connector through the aperture to an insertion depth, and securing the electrical connector to the plate.

In a further embodiment of any of the above, the choosing step includes selecting the electrical connector from a group consisting of at least one of the following: a 7-way connector, a 4-way connector, a 12-way connector, a data connector, and an electrical outlet.

In a further embodiment of any of the above, the method includes the step of choosing another electrical connector from the group, and installing the other electrical connector into another aperture in the plate by performing the same circumferentially aligning, inserting and securing steps.

In a further embodiment of any of the above, the circumferentially aligning step includes circumferentially aligning one of a notch and a protrusion at the aperture with the other of the notch and the protrusion on the electrical connector.

In a further embodiment of any of the above, the inserting step includes abutting an annular lip on the electrical connector with a recessed annular ledge that is provided relative to the face and about the aperture.

In a further embodiment of any of the above, the securing step is performed simultaneously with reaching the insertion depth during the inserting step.

In a further embodiment of any of the above, the securing step pushes a set of barbs on the electrical connector into a gap in the annular ledge. The barbs are received in the gap and locked relative to the annular lip at the insertion depth.

In a further embodiment of any of the above, the securing step includes pushing a clip into a groove on the electrical connector on a side opposite a face of the plate that is configured to have a cover that is arranged over the aperture.

In a further embodiment of any of the above, the method includes the step of securing a connector to the electrical connector on a side opposite a face of the plate. The face is configured to have a cover that is arranged over the aperture.

### BRIEF DESCRIPTION OF THE DRAWINGS

The disclosure can be further understood by reference to the following detailed description when considered in connection with the accompanying drawings wherein:

FIG. 1 is a schematic view of a vehicle pulling a trailer, with the vehicle having a trailer tow connector according to the disclosure.

FIG. 2A is a first example modular trailer tow connector having two example electrical connectors.

FIG. 2B is a cross-sectional view of a portion of the trailer tow connector shown in FIG. 2A installed in a vehicle mounting structure.

FIG. 2C is another example modular trailer tow connector.

FIG. 3 is an exploded view of the modular trailer tow connector shown in FIG. 2A.

FIG. 4 is a top view of the example trailer tow connector mounting plate show in FIG. 2A, with an optional retainer feature illustrated in dashed lines.

FIGS. 5A-5E illustrate example modular electrical connectors for use with the disclosed modular trailer tow connector.

FIG. 6A is an isometric rear view of one example trailer tow connector and an example retainer feature for securing the electrical connector to the plate.

FIG. 6B is an enlarged rear view of a portion of the modular trailer tow connector shown in FIG. 6A secured to the plate with the retainer feature.

FIGS. 7A-7C are respectively side, rear isometric, and enlarged cross-sectional views of another example retainer feature.

FIG. 8 illustrates a method of assembling the modular trailer tow connector.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

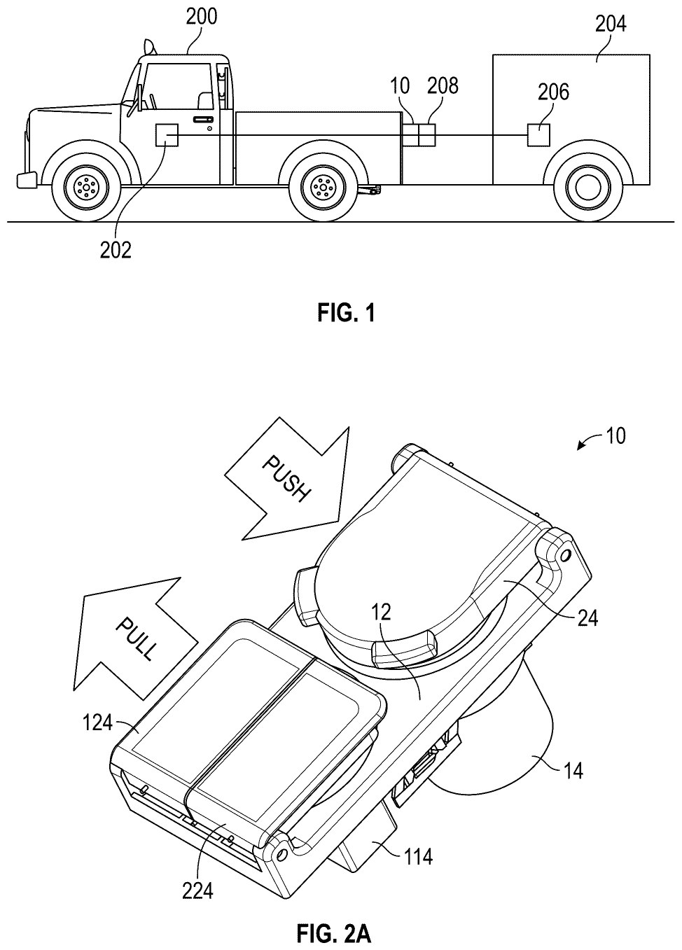

Referring to FIG. 1, the vehicle 200 is schematically shown towing a trailer 204. A trailer tow connector 10 provided on the vehicle 200 and is electrically coupled to a trailer connector 208 wired to at least one trailer component 206. At least one vehicle component 202 communicates to the at least one trailer component 206 via this electrical coupling to provide an electrical signal. In one example, the vehicle component 202 is at least one of a brake switch, a turn signal, a back-up switch, a power supply, a trailer brake controller, and a data bus. It is desirable to provide a modular trailer tow connector that is also structurally robust, as disclosed, to accommodate the many configurations desired by vehicle manufacturers and customers for numerous possible applications.

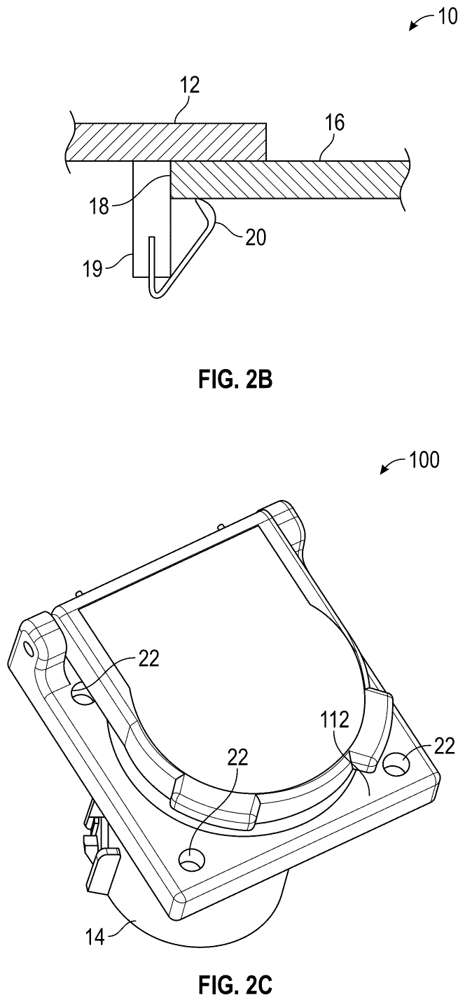

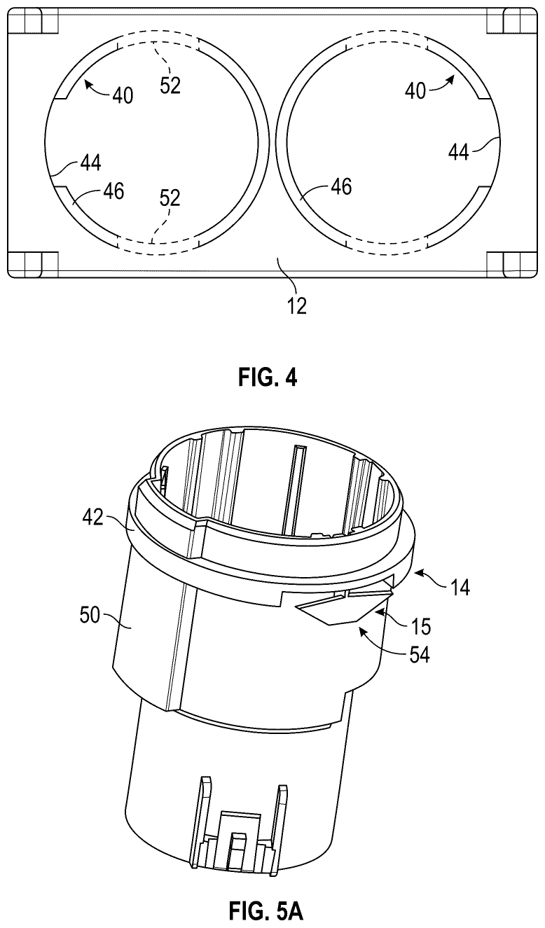

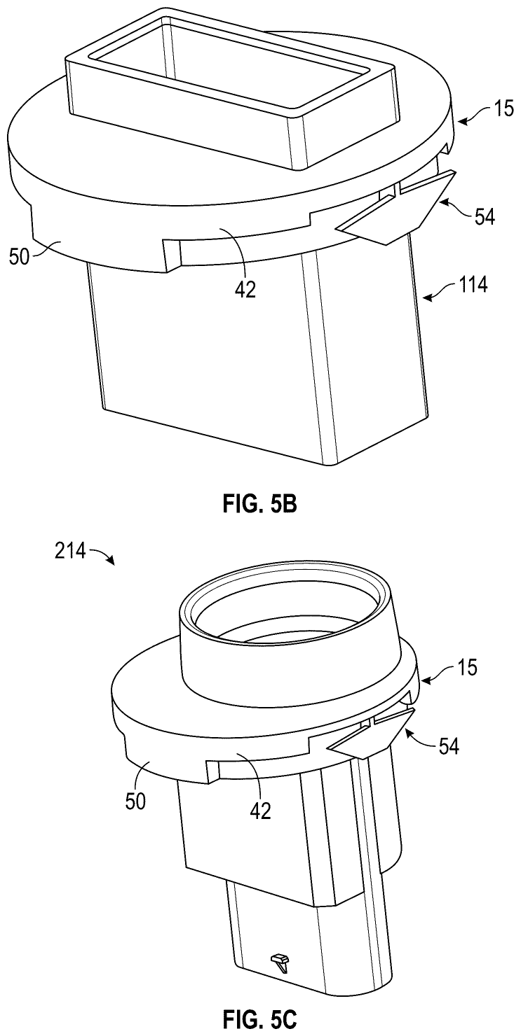

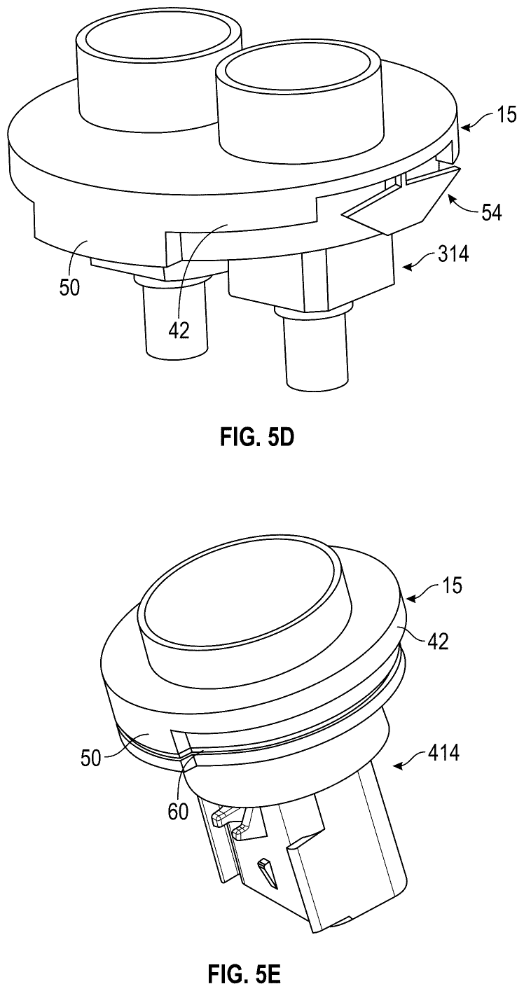

One example modular trailer tow connector 10 is illustrated in FIGS. 2A and 2B. The trailer tow connector 10 includes a mounting plate 12 that is configured to removable support numerous different electrical connectors 14, 114, 214, 314, 414 (examples shown in FIGS. 5A-5E; generally referred to as “electrical connector 14”) suited for the desired application. In one example, the electrical connectors that a manufacturer may typically choose from includes the a 7-way connector, a 4-way connector, a 12-way connector, a data connector (e.g., coaxial, USB, etc), and an electrical outlet (e.g., 12 volt, 110 volt AC, etc). Of course, other electrical connectors may also be used.

Referring to FIG. 2B, the plate 12 is secured to a vehicle mounting structure 16, such as a bumper, using a retaining configuration, such as clips 20 mounted to a pedestal 19 on a backside of the plate 12. The back side of the electrical connectors 14 extend through the opening 18 and are connected to a vehicle wiring harness, as is known. Another example trailer tow connector 100 has a single electrical connector 14, as shown in FIG. 2C. The plate 112 may use a different mounting configuration for the vehicle mounting structure, such as holes 22 for receiving fasteners (not shown) that secure the plate 112 to the vehicle.

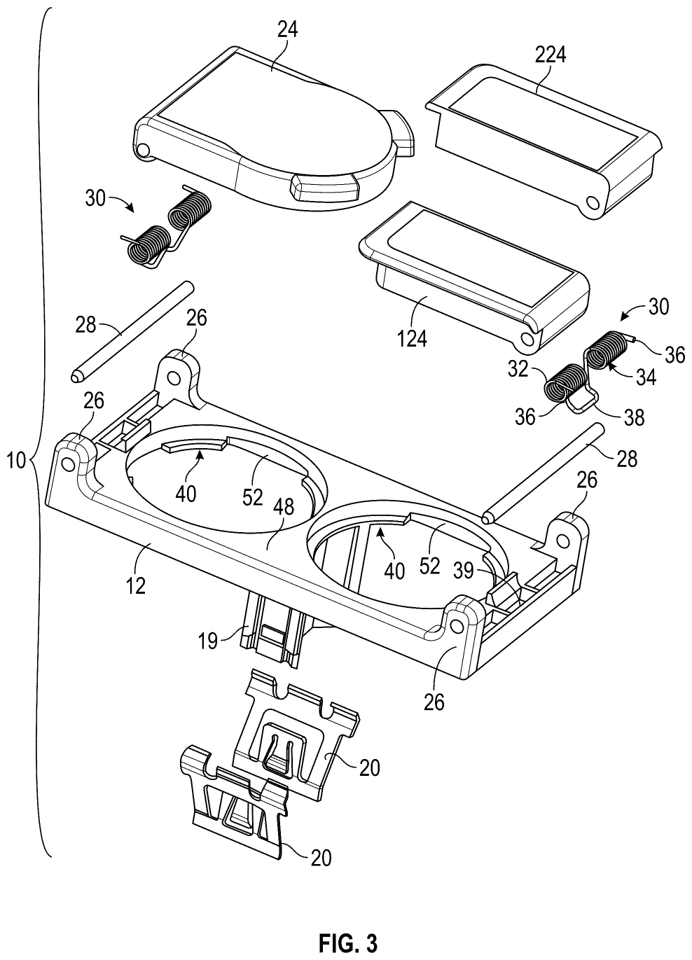

Referring to FIGS. 2A and 3, the plate 12 includes spaced apart ears 26 to which covers 24, 124, 224 (generally “cover(s) 24)”) are pivotally secured using a hinge pin 28 to secure the cover to the plate. Different cover configurations may be used depending upon the electrical connector 14 that is arranged beneath the cover. A torsion spring 30 is arranged coaxially about the hinge pin 28 and is universal such that the same spring 30 may be used for a single cover 24, or for small, adjacent covers 124, 224, which are operated independently of one another to selectively conceal its respective electrical connector. This is achieved, for example, by first and second portions 32, 34, each having an end 36 that cooperates with its respective cover. A U-shaped central portion 38 joins the first and second portions 32, 34 to one another and is received in a pocket 39 in the plate 12. The U-shaped central portion 38 accommodates the adjacent sidewalls of the covers 124, 224. The spring 30 biases its cover(s) to a closed position over its corresponding electrical connector adjacent an outer face 48 of the plate 12.

Since the modular trailer connector is assembled in a production environment, it is desirable to provide a locating feature that easily circumferentially orients the electrical connector relative to the plate quickly and accurately. In the example, each electrical connector 14 is received in an aperture 40 in the plate 12, which is circular in the example. In the example, the plate 12 is symmetrical, as shown in FIG. 4 in a plane bisecting the plate 12 between the apertures 40, which are substantially the same as one another in the example. An annular ledge 46 is provided at least partially about the aperture 40 and is recessed with respect to the outer face 48 of the plate 12. The annular ledge 46 has a notch 44 at one angular position, for example, the twelve o'clock position (“top” electrical connector when plate 12 is oriented vertically). The notch 44 cooperates with correspondingly shaped protrusion 50 (FIGS. 5A-5E) on a body 15 of the electrical connector 14 to circumferentially orient the electrical connector 14 relative to the plate 12. It should be understood that the locating features may be reversed, that is, the protrusion may be provided by the aperture and the notch provided by the electrical connector. Moreover, the locating feature may be provided by a square aperture in the plate that cooperates with a square body of the electrical connector.

As shown in FIG. 2A, the electrical connector 14 must withstand a PUSH force when the trailer connector is inserted into the electrical connector 14. To this end, the annular ledge 46 acts as a stop to an annular lip 42 that circumscribes the body 15 of the electrical connector 14 (see, FIGS. 5A-5E). The stop limits the electrical connector 14 to an insertion depth relative to the face 48 during assembly such that annular lip 42 seated against the annular ledge 46.

It is also desirable to prevent the electrical connector 14 from being dislodged from the plate 12 in response to a PULL force (FIG. 2A) when the trailer connector is removed from the electrical connector 14. To this end, a retainer is provided on the body 15, for example, one on each side, to secure the electrical connector 14 to the plate 12 and retain the electrical connector 14 at the insertion depth achieved at assembly.

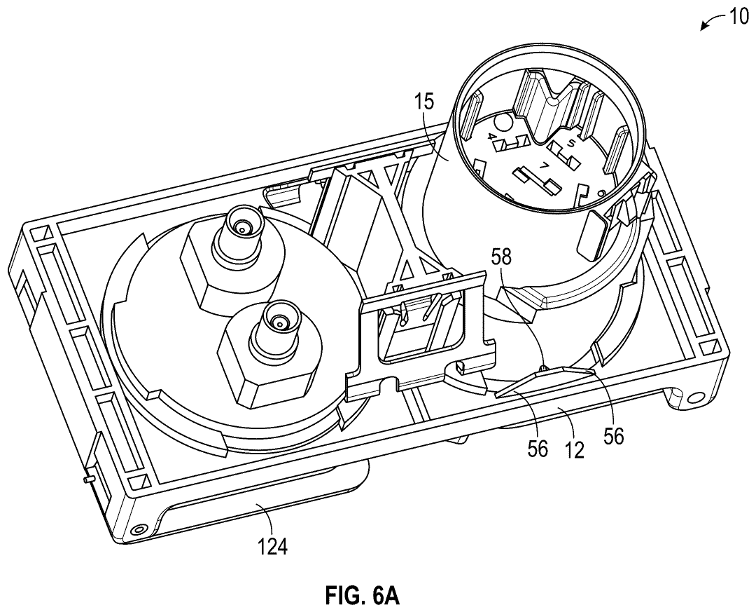

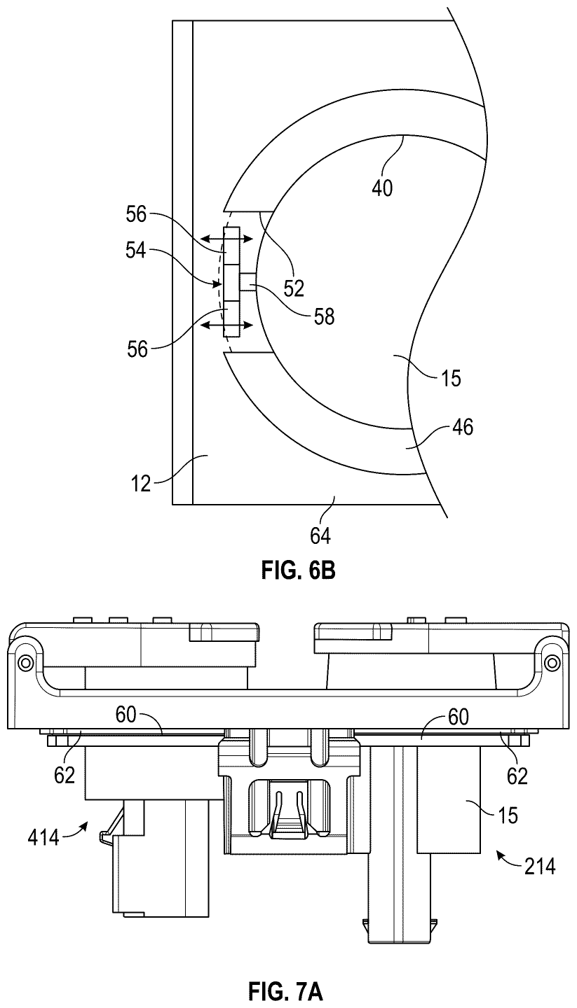

Referring to FIGS. 6A and 6B, the retainer is provided by a pair of barbs 54, which are flexible in the lateral direction, indicated by the arrows in FIG. 6B. A gap 52 is provided in the annular ledge 46 to accommodate the barbs 54. The gaps 52 are a different size or shape (e.g., smaller) than the notch 44, preventing the electrical connector 14 from being clocked differently than desired. The barbs 54 have tapered surfaces and are joined to the body 15 by a reinforcing rib 58 for additional structural integrity. During assembly, the tapered surfaces 56 ride along the aperture 40 and flex inward toward the body 15 until the electrical connector 14 is seated at the insertion depth at which point the barbs 54 return to their original position where they abut against a surface 64 of the plate 12 on the opposite side from the covers 24.

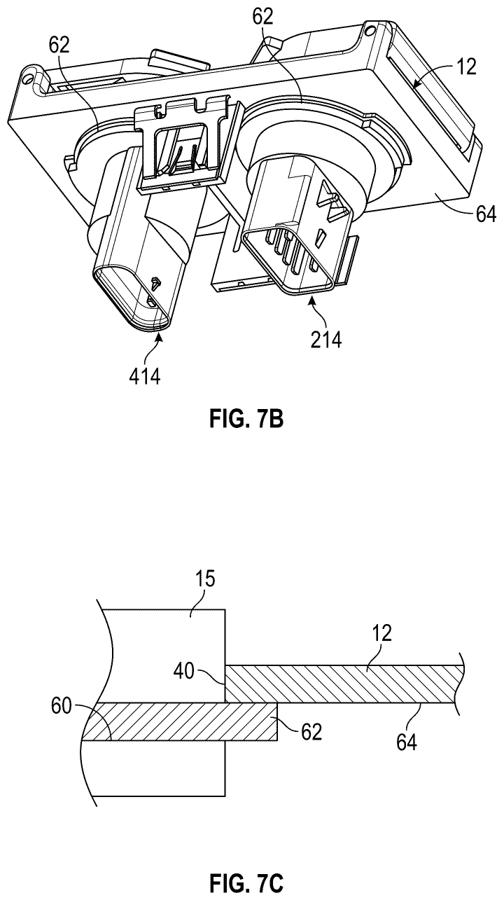

Another retainer configuration is shown in FIGS. 7A-7C. In this example, the body 15 includes a groove 60 which receives a C-shaped clip 62 when the electrical connector 14 is arranged at the insertion depth. The clip 62 is in close proximity to or abutment with the surface 64 preventing the electrical connector 14 from being pulled from the plate. The gaps 52 (dashed lines in FIG. 4) may be omitted from this type of retainer configuration, if desired.

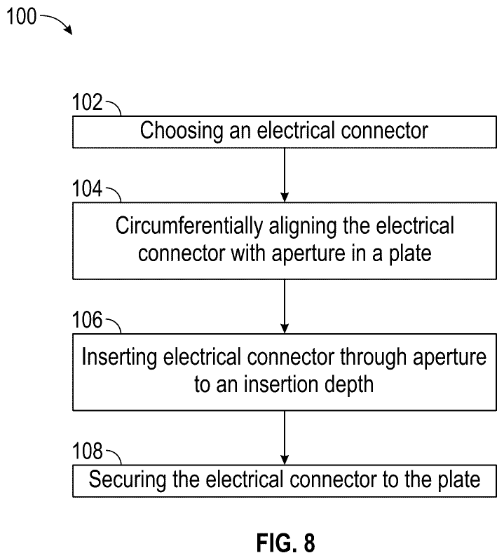

A method of assembling a modular trailer tow connector is shown at 100 in FIG. 8. The method includes the step of choosing an electrical connector 14 from multiple optional configurations (block 102). The electrical connector 14 is circumferentially aligned relative to an aperture 40 in a plate 14 (block 104). In one example, the circumferentially aligning step includes circumferentially aligning one of a notch 44 and a protrusion 50 at the aperture 40 with the other of the notch 44 and the protrusion 50 on the electrical connector 14. The electrical connector 14 is inserted through the aperture 40 to an insertion depth (block 106). In one example, the inserting step includes abutting an annular lip 42 on the electrical connector 14 with a recessed annular ledge 46 provided relative to the face 48 and about the aperture 40.

The electrical connector 14 is secured to the plate 12 (block 108). In one example, the securing step is performed simultaneously with reaching the insertion depth during the inserting step. In one example, the securing step includes pushing a set of barbs 54 on the electrical connector 14 into a gap 52 in the annular ledge 46. The barbs 54 are received in the gap 52 and are locked relative to the annular lip 42 at the insertion depth. In another example, the securing step includes pushing a clip 62 into a groove 60 on the electrical connector 14 on a side 64 opposite a face 48 of the plate 14 that is configured to have a cover 24 arranged over the aperture 40.

A commonly used electrical connector 14, such as a 7-way connector, may be integrally formed with the plate 12, and the aperture 40 may be provided in the plate 12 to accommodate another electrical connector of the customer's choosing. In this matter, assembly time may be reduced by requiring assembly of only one electrical connector.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A trailer tow connector comprising:
a plate with an aperture in a face of the plate;
a cover pivotally supported by the plate for selectively concealing the aperture;
an electrical connector removably received in the aperture;
a locating feature configured to circumferentially orient the electrical connector relative to the plate;
a stop configured to limit the electrical connector to an insertion depth relative to the face; and
a retainer configured to secure the electrical connector to the plate at the insertion depth.

2. The trailer tow connector of claim 1, wherein the plate includes two apertures that are substantially the same as one another.

3. The trailer tow connector of claim 2, wherein the two apertures are substantially the same in relation to at least the locating feature and the stop.

4. The trailer tow connector of claim 1, wherein the electrical connector is selecting from a group consisting of at least one of the following:
a 7-way connector;
a 4-way connector;
a 12-way connector;
a data connector; and
an electrical outlet.

5. The trailer tow connector of claim 1, wherein the cover is pivotally secured to the plate at the face by a hinge, and a spring is provided at the hinge and between the plate and the cover to bias the cover to a closed position over the aperture.

6. The trailer tow connector of claim 1, wherein the locating feature is provided by one of a notch and a protrusion at the aperture, and by the other of the notch and the protrusion on the electrical connector, the locating feature providing a single angular orientation of the electrical connector relative to the plate.

7. The trailer tow connector of claim 1, wherein the stop is provided by a recessed annular ledge relative to the face and about the aperture, and by an annular lip on the electrical connector, the annular lip seated against the annular ledge at the insertion depth.

8. The trailer tow connector of claim 7, wherein the retainer is provided by a gap in the annular ledge, and by a set of barbs on the electrical connector, the barbs received in the gap and locked relative to the annular lip at the insertion depth.

9. The trailer tow connector of claim 1, wherein the retainer is provided by a clip received in a groove on the electrical connector on a side opposite the face.

10. A vehicle comprising the trailer tow connector of claim 1, the vehicle including a component in communication with the electrical connector and configured to provide an electrical signal thereto.

11. The vehicle of claim 10, wherein the component is at least one of a brake switch, a turn signal, a back-up switch, a power supply, a trailer brake controller, and a data bus.

12. A method of assembling a modular trailer tow connector, comprising:
choosing an electrical connector;
circumferentially aligning the electrical connector relative to an aperture in a plate;
inserting the electrical connector through the aperture to an insertion depth; and
securing the electrical connector to the plate.

13. The method of claim 12, wherein the choosing step includes selecting the electrical connector from a group consisting of at least one of the following:
a 7-way connector;
a 4-way connector;
a 12-way connector;
a data connector; and
an electrical outlet.

14. The method of claim 13, comprising the step of choosing another electrical connector from the group, and installing the other electrical connector into another aperture in the plate by performing the same circumferentially aligning, inserting and securing steps.

15. The method of claim 12, wherein the circumferentially aligning step includes circumferentially aligning one of a notch and a protrusion at the aperture with the other of the notch and the protrusion on the electrical connector.

16. The method of claim 12, wherein the inserting step includes abutting an annular lip on the electrical connector with a recessed annular ledge provided relative to the face and about the aperture.

17. The method of claim 16, wherein the securing step is performed simultaneously with reaching the insertion depth during the inserting step.

18. The method of claim 17, wherein the securing step pushing a set of barbs on the electrical connector into a gap in the annular ledge, the barbs received in the gap and locked relative to the annular lip at the insertion depth.

19. The method of claim 12, wherein the securing step includes pushing a clip into a groove on the electrical connector on a side opposite a face of the plate configured to have a cover arranged over the aperture.

20. The method of claim 12, comprising the step of securing a connector to the electrical connector on a side opposite a face of the plate, the face configured to have a cover arranged over the aperture.
